(19) United States
(12) Patent Application Publication
(10) Pub. No.: US 2025/0363691 A1
(43) Pub. Date: Nov. 27, 2025

(54) IMAGE PROCESSING APPARATUS AND METHOD, ELECTRONIC APPARATUS, AND STORAGE MEDIUM

(71) Applicant: CANON KABUSHIKI KAISHA, Tokyo (JP)

(72) Inventor: RYOSUKE TAKAHASHI, Kanagawa (JP)

(21) Appl. No.: 19/196,073

(22) Filed: May 1, 2025

(30) Foreign Application Priority Data
May 21, 2024 (JP) 2024-082894

(51) Int. Cl. G06T 11/60; G06T 5/90

(52) U.S. Cl. CPC G06T 11/60; G06T 5/90; G06T 2207/20208; G06T 2207/20212

(57) ABSTRACT

An image processing apparatus comprises: a superimposition unit that performs superimposition processing for superimposing an object on first image data of a first dynamic range, the first image data being associated with a first gain map for converting the first dynamic range into a second dynamic range, to generate superimposed image data; a generating unit that obtains a conversion characteristic for converting image data of the object into image data of the second dynamic range based on a luminance of the object, and generates a second gain map for converting the superimposed image data into second image data of the second dynamic range using the conversion characteristic; and an updating unit that updates an image file consisting of the first image data and the first gain map by using the superimposed image data and the second gain map.

### BACKGROUND

### Technical Field

The aspect of the embodiments relates to an image processing apparatus and method, an electronic apparatus, and a storage medium.

### Description of the Related Art

Conventionally, technology is known that uses a gain map that describes the gain that corresponds to each region in order to apply different gains to different regions of an image.

For example, Japanese Patent Laid-Open No. 2007-4675 discloses a technique relating to a gain map that associates different gains with respective regions of an image.

Further, in recent years, with the increase in display brightness in a display, a High Dynamic Range (HDR) camera system has been proposed that can capture images that allows gradations in high-brightness region that are previously compressed to be reproduced with gradations closer to real gradations. HDR can express a wider dynamic range than Standard Dynamic Range (SDR).

Here, in a case where an HDR image is to be displayed on a display device designed for SDR (hereinafter referred to as an “SDR display device”), it is necessary to convert the HDR image to an SDR image, and it is conceivable to use a gain map in this conversion. For example, by generating and linking the HDR image to a gain map for converting to an SDR image, it is possible to hold conversion information from HDR to SDR for each region of the HDR image.

Furthermore, in a case where an SDR image is displayed on a display device designed for HDR, (hereinafter referred to as an “HDR display device”), it is possible to convert the SDR image into an image suitable for the HDR display device by using a gain map.

Here, it is conceivable to superimpose an object such as a character on an HDR image to which a gain map is associated. In this case, when the HDR image on which the object is superimposed is converted into an SDR image using a gain map associated with the HDR image, the converted image is not as expected.

### SUMMARY

According to a first aspect of the embodiments, an image processing apparatus comprising one or more processors and/or circuitry which function as: a superimposition unit that performs superimposition processing for superimposing an object on first image data of a first dynamic range, the first image data being associated with a first gain map for converting the first dynamic range into a second dynamic range, to generate superimposed image data; a generating unit that obtains a conversion characteristic for converting image data of the object into image data of the second dynamic range based on a luminance of the object, and generates a second gain map for converting the superimposed image data into second image data of the second dynamic range using the conversion characteristic; and an updating unit that updates an image file consisting of the first image data and the first gain map by using the superimposed image data and the second gain map.

Further, according to a second aspect of the embodiments, provided is an electronic apparatus comprising: an image processing apparatus comprising one or more processors and/or circuitry which function as: a superimposition unit that performs superimposition processing for superimposing an object on first image data of a first dynamic range, the first image data being associated with a first gain map for converting the first dynamic range into a second dynamic range, to generate superimposed image data; a generating unit that obtains a conversion characteristic for converting image data of the object into image data of the second dynamic range based on a luminance of the object, and generates a second gain map for converting the superimposed image data into second image data of the second dynamic range using the conversion characteristic; and an updating unit that updates an image file consisting of the first image data and the first gain map by using the superimposed image data and the second gain map, and an image sensing unit that performs shooting, generates and outputs image data of the first dynamic range.

Furthermore, according to a third aspect of the embodiments, provided is an electronic apparatus comprising: an image processing apparatus comprising one or more processors and/or circuitry which function as: a superimposition unit that performs superimposition processing for superimposing an object on first image data of a first dynamic range, the first image data being associated with a first gain map for converting the first dynamic range into a second dynamic range, to generate superimposed image data; a generating unit that obtains a conversion characteristic for converting image data of the object into image data of the second dynamic range based on a luminance of the object, and generates a second gain map for converting the superimposed image data into second image data of the second dynamic range using the conversion characteristic; and an updating unit that updates an image file consisting of the first image data and the first gain map by using the superimposed image data and the second gain map, and an output unit that converts the image data of the first dynamic range included in the image file output from the image processing apparatus using a gain map included in the image file, and outputs the converted image data to a display device of the second dynamic range.

Further, according to a fourth aspect of the embodiments, provided is an image processing method comprising: performing superimposition processing for superimposing an object on first image data of a first dynamic range, the first image data being associated with a first gain map for converting the first dynamic range into a second dynamic range, to generate superimposed image data; obtaining a conversion characteristic for converting image data of the object into image data of the second dynamic range based on a luminance of the object, and generating a second gain map for converting the superimposed image data into second image data of the second dynamic range using the conversion characteristic; and updating an image file consisting of the first image data and the first gain map by using the superimposed image data and the second gain map.

Further, according to a fifth aspect of the embodiments, provided is a non-transitory computer-readable storage medium, the storage medium storing a program that is executable by the computer, wherein the program includes program code for causing the computer to function as an image processing apparatus comprising: a superimposition unit that performs superimposition processing for superimposing an object on first image data of a first dynamic range, the first image data being associated with a first gain map for converting the first dynamic range into a second dynamic range, to generate superimposed image data; a generating unit that obtains a conversion characteristic for converting image data of the object into image data of the second dynamic range based on a luminance of the object, and generates a second gain map for converting the superimposed image data into second image data of the second dynamic range using the conversion characteristic; and an updating unit that updates an image file consisting of the first image data and the first gain map by using the superimposed image data and the second gain map.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of a configuration of an image processing apparatus according to a first embodiment of the disclosure.

FIG. 2A is a diagram illustrating an example of a scene to be shot according to the first embodiment.

FIG. 2B is a diagram illustrating an example of an HDR image according to the first embodiment.

FIG. 2C is a diagram illustrating an example of an SDR image according to the first embodiment.

FIG. 2D is a diagram illustrating an example of a gain map according to the first embodiment.

FIG. 3 is a diagram illustrating a relationship between luminance of a subject and luminance values of an HDR image and an SDR image.

FIG. 4 is a flowchart illustrating processing in a case where an object is superimposed according to the first embodiment.

FIG. 5 is a conceptual diagram of object superimposition processing according to the first embodiment.

FIGS. 6A and 6B are conceptual diagrams illustrating a configuration of a superimposition image file and superimposition information according to the first embodiment.

FIG. 7 is a diagram illustrating conversion characteristics according to luminance of an object region according to the first embodiment.

FIG. 8 is a conceptual diagram of a gain map synthesis method according to the first embodiment.

FIG. 9 is a block diagram illustrating an example of a configuration of an image processing apparatus according to a second embodiment.

FIG. 10 is a flowchart illustrating processing in a case where an object is superimposed according to the second embodiment.

FIGS. 11A to 11C are diagrams for explaining a superimposed gain map according to the second embodiment.

FIG. 12 is a block diagram illustrating an example of a configuration of an image processing apparatus according to a third embodiment.

FIG. 13 is a flowchart illustrating processing in a case where an object is superimposed according to the third embodiment.

FIGS. 14A and 14B are conceptual diagrams of object superimposition processing according to the third embodiment.

FIG. 15 is a conceptual diagram of an updated superimposition image file according to the third embodiment.

FIG. 16 is a block diagram illustrating a schematic configuration of an image capturing apparatus according to a fourth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

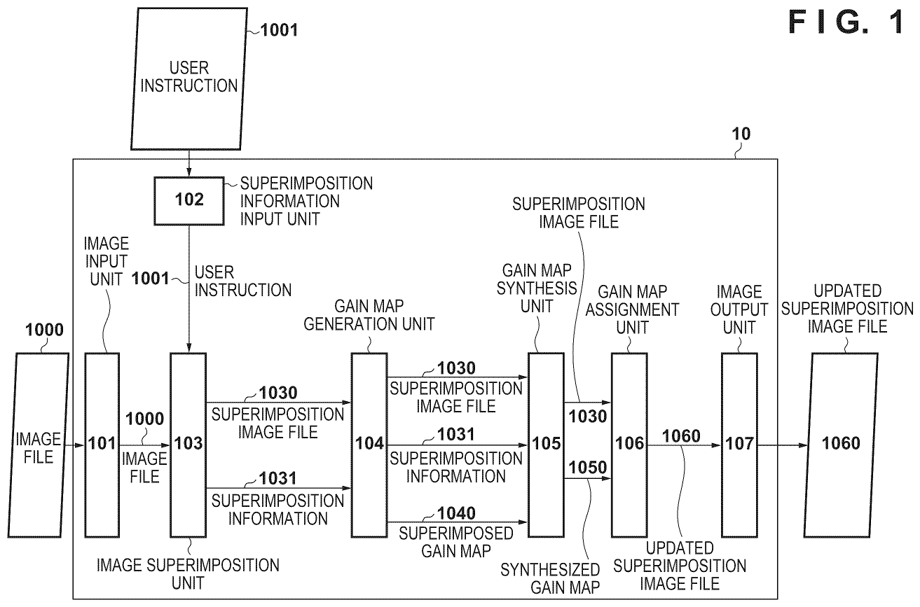

FIG. 1 is a block diagram illustrating an exemplary functional configuration of an image processing apparatus 10 according to a first embodiment.

The image processing apparatus 10 includes an image input unit 101, a superimposition information input unit 102, an image superimposition unit 103, a gain map generation unit 104, a gain map synthesis unit 105, a gain map assignment unit 106, and an image output unit 107.

The image input unit 101 inputs an image file 1000 that is configured from HDR image data, which is image data of an HDR image, and a gain map to be used in processing to convert the HDR image into an SDR image.

Now, an HDR image, an SDR image, and a gain map will be described in detail.

In this embodiment, an HDR image is an image having a wider dynamic range than an SDR image and, for example, a YUV image to which the Opto-Electronic Transfer Function (OETF) characteristics described in ST2084, which is an HDR standard dealt with in HDR display devices, are applied. Also, an SDR image is a YUV image having a narrower dynamic range than an HDR image and, for example, a YUV image to which the sRGB gamma characteristics are applied. Note that in this embodiment, the gamma for an HDR image is referred to as HDR gamma, and the gamma for an SDR image is referred to as SDR gamma, and the description will be given assuming that the color gamuts are common.

In addition, the gain map of this embodiment is one-channel data having gain information for the same number of pixels as that of the image to which the gain map is added. The gain map of this embodiment records the ratio of the Y components of each pixel between an HDR image and an SDR image after being degammaed. Therefore, conversion from an HDR image to an SDR image can be performed by degammaing the HDR image, changing the Y component of each pixel with reference to the gain in the gain map, and then applying SDR gamma. Conversely, conversion from an SDR image to an HDR image can be performed by degammaing the SDR image, changing the Y component of each pixel with reference to the gain in the gain map, and then applying HDR gamma.

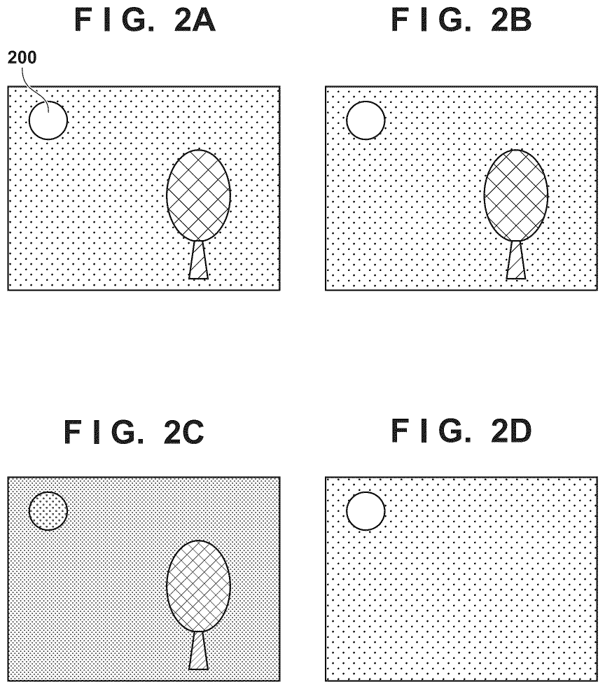

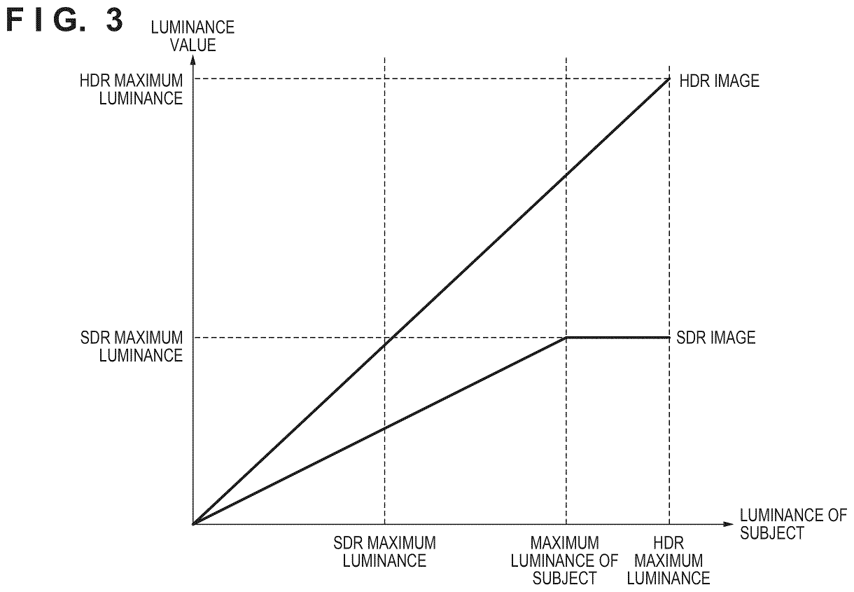

The relationship between an HDR image, an SDR image, and a gain map will be described more specifically below with reference to FIGS. 2A to 2D and FIG. 3.

FIG. 2A is a diagram illustrating an example of a scene to be shot, where a region 200 is the region with the highest brightness in the scene. FIG. 2B is a diagram showing an example of an HDR image generated by performing image processing on image data obtained by shooting the scene shown in FIG. 2A with an image capturing apparatus. FIG. 2C is a diagram showing an example of an SDR image generated by performing image processing on the same image data as FIG. 2B. FIG. 2D is a diagram showing an example of a gain map that enables mutual conversion between the images shown in FIG. 2B and FIG. 2C.

The image file 1000 input to the image input unit 101 consists of the HDR image shown in FIG. 2B and the gain map shown in FIG. 2D.

FIG. 3 is a graph showing the relationship between the luminance of a subject and the luminance values in an HDR image and an SDR image, with the horizontal axis representing the luminance of the subject and the vertical axis representing the luminance value of an image signal.

Here, the luminance of the brightest region 200 in the scene shown in FIG. 2A (maximum luminance of subject) is assumed to be lower than the maximum luminance that can be displayed on an HDR display device and higher than the maximum luminance that can be displayed on an SDR display device. In the case of an HDR image, the luminance of the region 200 can be directly assigned as the luminance value for the HDR display device, so that each luminance of the scene can be directly converted to the luminance value of the HDR image. On the other hand, since the maximum luminance that can be displayed on an SDR display device is lower than the luminance of the region 200, in the case of an SDR image, a luminance value is assigned so that the luminance of the region 200 is the maximum luminance value of the SDR image.

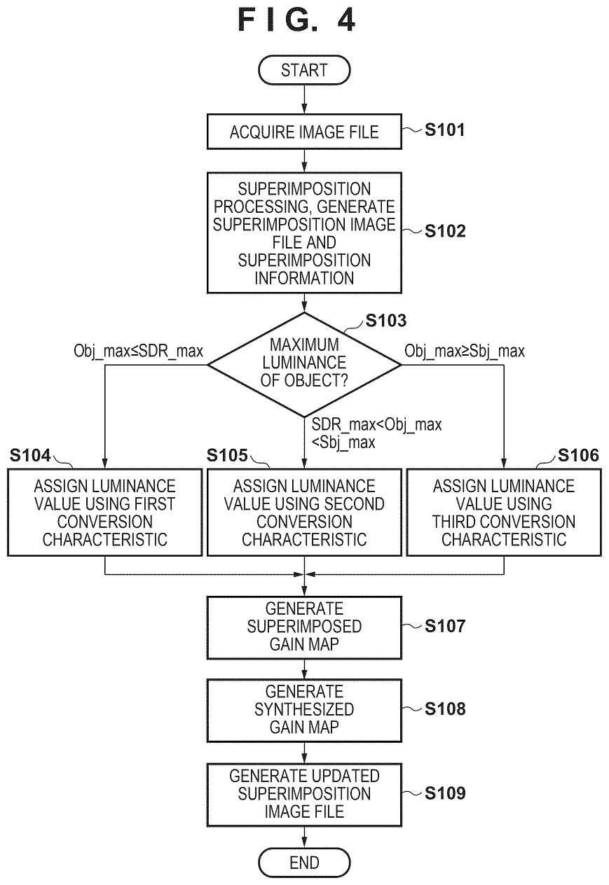

Next, the processing performed in the first embodiment in a case where an object is superimposed on an image will be described with reference to the flowchart of FIG. 4.

First, in step S101, the image input unit 101 acquires an image file 1000, and outputs the acquired image file 1000 to the image superimposition unit 103.

In step S102, the superimposition information input unit 102 receives a user instruction 1001, which is an instruction for image superimposition processing, from a user. The superimposition information input unit 102 is composed of, for example, a display that displays an image and the contents of object superimposition processing to the user, and a mouse and/or a touch panel that receives the user instruction. The user uses the superimposition information input unit 102 to instruct what type of superimposition processing to be performed on the image. The superimposition information input unit 102 outputs the received user instruction 1001 to the image superimposition unit 103.

The image superimposition unit 103 is a processing unit that performs superimposition processing on an image, and performs object superimposition processing on the HDR image data contained in the input image file 1000 based on the input user instruction 1001, thereby generating superimposed image data.

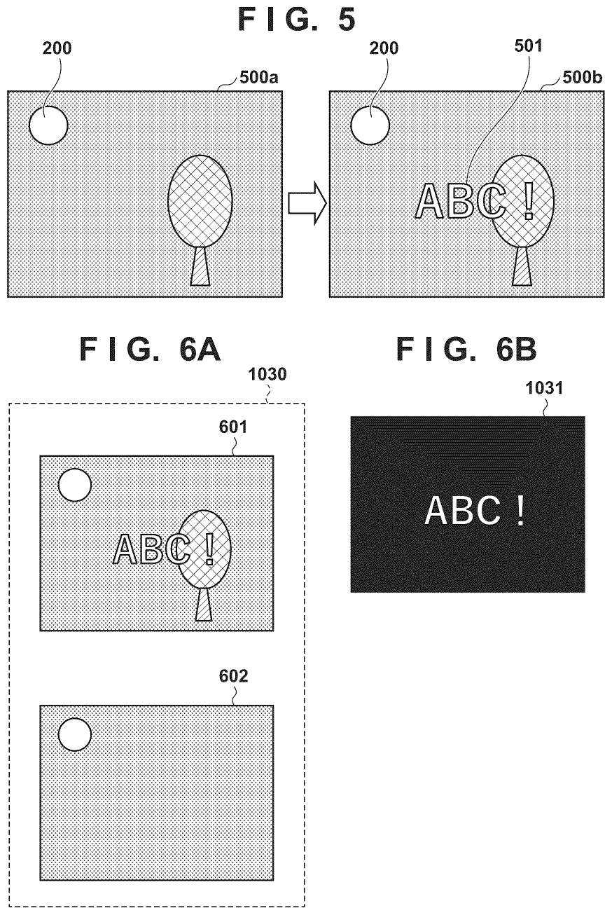

FIG. 5 is a diagram showing an example of an image obtained in a case where input HDR image data is subjected to superimposition processing for superimposing an object 501. An image 500a shows an example of the image before the object is superimposed, and an image 500b shows an example of the image after the object is superimposed.

The image superimposition unit 103 also generates a superimposition image file 1030 composed of the generated superimposed image data and a gain map included in the image file 1000, and generates superimposition information 1031 indicating what kind of superimposition processing was performed on the image. Here, the superimposition information 1031 includes, for example, region information of a region where the object is superimposed on the image.

FIG. 6A is a conceptual diagram illustrating the superimposition image file 1030, and FIG. 6B is a conceptual diagram illustrating superimposition information 1031. FIG. 6A shows an example of superimposed image data 601 and a gain map 602 included in the superimposition image file 1030. Note that the gain map 602 is the same as the gain map shown in FIG. 2D.

The image superimposition unit 103 outputs the generated superimposition image file 1030 and superimposition information 1031 to the gain map generation unit 104.

The gain map generation unit 104 generates a new gain map based on the input superimposition image file 1030 and superimposition information 1031. More specifically, the gain map generation unit 104 degammas the superimposed image data contained in the input superimposition image file 1030, and calculates which luminance of each pixel corresponds to which luminance values of the HDR image and the SDR image.

At this time, first, in step S103, when calculating the allocation of luminace values of the SDR image, the gain map generation unit 104 detects the maximum luminance Obj_max of the region where the object is superimposed (object region) by using the superimposed region information included in the superimposition information 1031. Then, it is determined whether the maximum luminance Obj_max of the detected object region is equal to or less than the maximum luminance SDR_max that can be represented by the SDR display device, is greater than the maximum luminance SDR_max that can be represented by the SDR display device and is smaller than the maximum luminance Sbj_max of the subject (luminance of the region 200), or is equal to or greater than the maximum luminance Sbj_max of the subject.

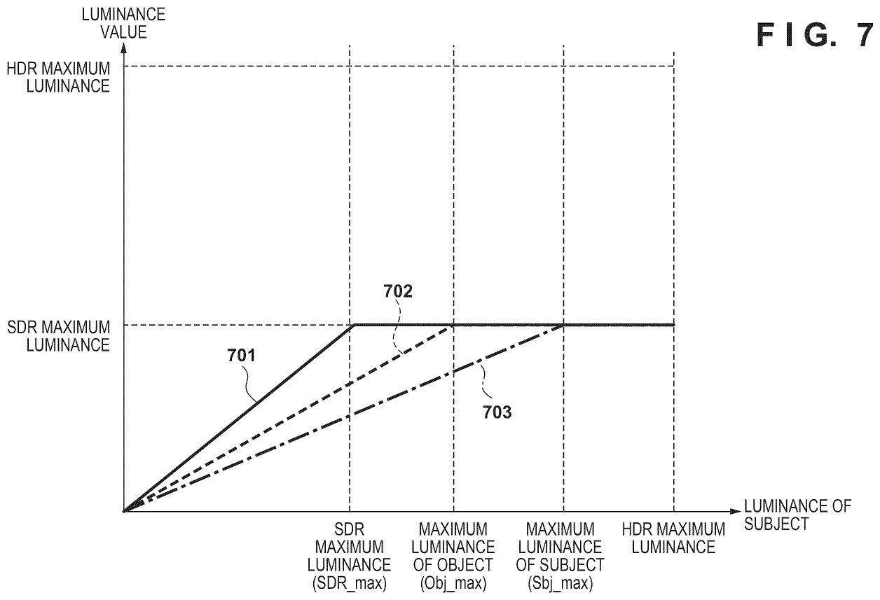

If the maximum luminance Obj_max of the object region is equal to or less than the maximum luminance SDR_max of the SDR display device, the process proceeds to step S104, where a first conversion characteristic as shown in graph 701 of FIG. 7 is selected. Then, a luminance value is assigned to the luminance obtained by degammaing the superimposed image data 601 included in the input superimposition image file 1030, using the first conversion characteristic. If the maximum luminance Obj_max of the object region is greater than the maximum luminance SDR_max of the SDR display device and less than the maximum luminance Sbj_max of the subject, the process proceeds to step S105, where a luminance value is assigned using a second conversion characteristic as shown in graph 702. If the maximum luminance Obj_max of the object region is equal to or greater than the maximum luminance Sbj_max of the subject, the process proceeds to step S106, where a luminance value is assigned using a third conversion characteristic as shown in graph 703.

Here, a case where the maximum luminance Obj_max of the object region is greater than the maximum luminance SDR_max of the SDR display device and less than the maximum luminance Sbj_max of the subject will be described in more detail. In a case where the maximum luminance Sbj_max of the subject is assigned to be the maximum luminance value of the SDR image (graph 703), the maximum luminance Obj_max of the object region is greater than the maximum luminance SDR_max of the SDR display device, but due to the influence of the luminance of other regions (here, the maximum luminance Sbj_max of the subject), a luminance less than the maximum luminance of the SDR image is assigned. In this case, for example, if white characters such as a caption or a shooting date and time are superimposed on an image as the object, the luminance of the superimposed region is reduced due to the influence of a higher luminance region other than the superimposed region, and the luminance of the white characters in the SDR image may be reduced to a level that makes them look gray.

Therefore, in this embodiment, a conversion characteristic is used that assigns the maximum luminance Obj_max of the object region to the maximum luminance value of the SDR image, as shown in the graph 702. By assigning in this manner, the maximum luminance of the object region can be assigned to the luminance value of the SDR image without being affected by the luminance of other regions. That is, the slope up to the maximum luminance Obj_max of the object region in the graph 702 changes between a slope in which the maximum luminance Obj_max is assigned to the maximum luminance value of the SDR display device and a slope in which the maximum luminance Sbj_max of the subject is assigned to the maximum luminance value of the SDR display device, depending on the magnitude of the maximum luminance Obj_max.

In step S107, the gain map generation unit 104 converts the luminance obtained by degammaing the superimposed image data 601 included in the input superimposition image file 1030 into an HDR image using the conversion characteristic shown in FIG. 3. Then, a superimposed gain map 1040 is generated by recording the ratio of the Y components of each corresponding pixel between the converted HDR image and an image converted in any one of steps S104 to S106. Then, the superimposition image file 1030, the superimposition information 1031, and the superimposed gain map 1040 are output to the gain map synthesis unit 105.

Then, in step S108, the gain map synthesis unit 105 generates a synthesized gain map 1050 based on the input superimposition image file 1030, superimposition information 1031, and superimposed gain map 1040.

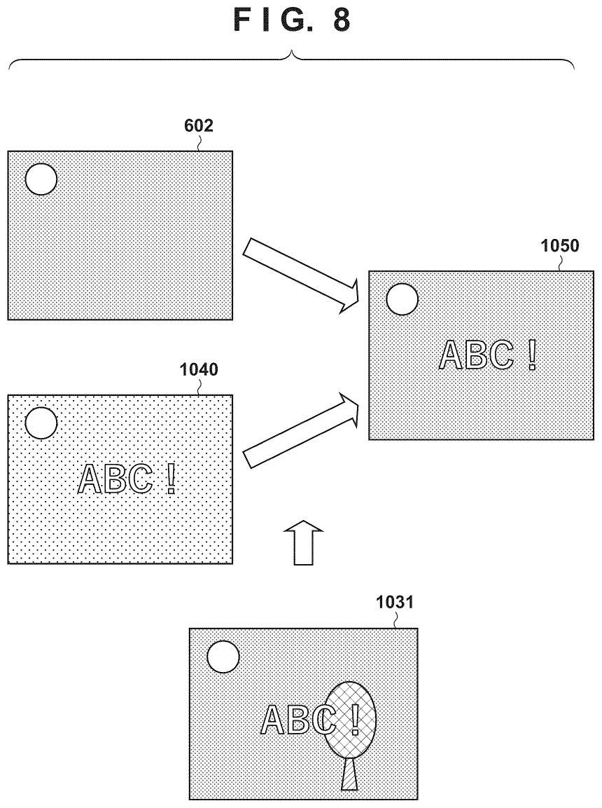

In this embodiment, the synthesis method involves obtaining the region where the object is superimposed from the superimposition information 1031, and replacing the gain of superimposed region of the object, of the gain in the gain map 602 included in the superimposition image file 1030, with the gain of the superimposed gain map 1040. In this way, the synthesized gain map 1050 is generated. FIG. 8 is a conceptual diagram illustrating the gain map synthesis method of this embodiment.

In this embodiment, the method of synthesizing gain maps has been described in which the gain of the superimposed region of the object in the original gain map is replaced with the gain of the gain map of the superimposed region of the object, but the method of synthesizing gain maps is not limited to this.

For example, the gain map 602 and the superimposed gain map 1040 may be compared for each pixel, and the larger gain may be used as the gain of the synthesized gain map. Also, for example, if an object is semi-transparent and the original image and the object are to be composited at a certain composite ratio, a synthesis method may be used in which the gain of the gain map 602 and the gain of the superimposed gain map 1040 are composited according to the composite ratio.

The gain map synthesis unit 105 outputs the superimposition image file 1030 and the generated synthesized gain map 1050 to the gain map assignment unit 106.

In step S109, the gain map assignment unit 106 assigns the synthesized gain map 1050 to the superimposed image data 601 included in the input superimposition image file 1030, and generates an updated superimposition image file 1060 consisting of the superimposed image data 601 and the synthesized gain map 1050. Then, the gain map assignment unit 106 outputs the generated updated superimposition image file 1060 to the image output unit 107.

The image output unit 107 is a processing unit that outputs an image, and outputs the input updated superimposition image file 1060 to the outside.

As described above, according to the first embodiment, in a case where an object is superimposed on an image to which a gain map is assigned, it is possible to generate a gain map corresponding to the superimposition processing. As a result, in a case where conversion is performed between an HDR image and an SDR image using the gain map, an image that the user expects can be obtained.

### Second Embodiment

Next, a second embodiment of the disclosure will be described.

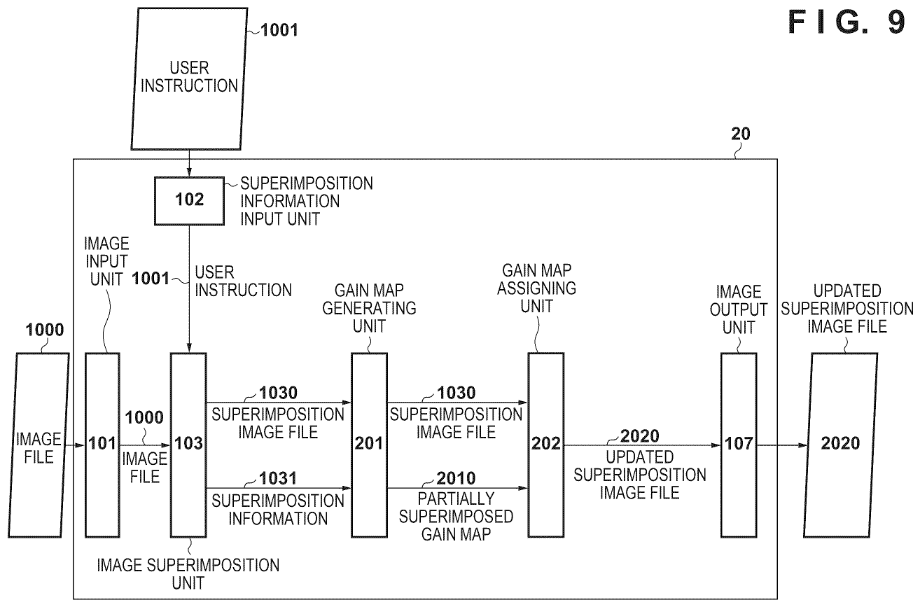

FIG. 9 is a block diagram illustrating an exemplary functional configuration of an image processing apparatus 20 according to the second embodiment.

The image processing apparatus 20 has an image input unit 101, a superimposition information input unit 102, an image superimposition unit 103, a gain map generating unit 201, a gain map assigning unit 202, and an image output unit 107. Note that in FIG. 9, components similar to those shown in FIG. 1 described in the first embodiment are given the same reference numerals, and the description thereof will be omitted.

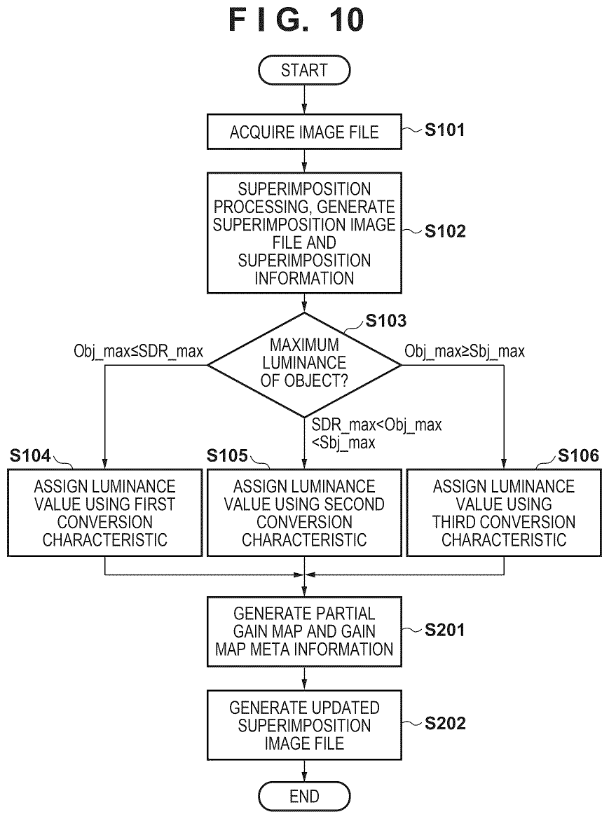

The process of superimposing an object on an image, which is performed in the second embodiment, will be described below with reference to the flowchart in FIG. 10. Note that in the processes shown in FIG. 10, the same processes as those described in the first embodiment with reference to FIG. 4 are given the same step numbers and the description thereof will be omitted.

In step S201, the gain map generating unit 201 generates a superimposed gain map that records the ratio of the Y components of each corresponding pixel between the image converted in any one of steps S104 to S106 and the HDR image converted using the conversion characteristic shown in FIG. 3 with respect to the luminance obtained by degammaing the superimposed image data 601 included in the input superimposition image file 1030. Then, in order to reduce the data size of the superimposed gain map, the superimposed gain map is divided into blocks (30 divisions horizontally and 20 divisions vertically in this embodiment), and a partial gain map is generated based on the superimposition information 1031, in which only blocks corresponding to the region where the object is superimposed are left. Then, a partially superimposed gain map 2010 is generated by combining the generated partial gain map with gain map meta information that is information on whether or not a partial gain map corresponding to each of the divided blocks exists.

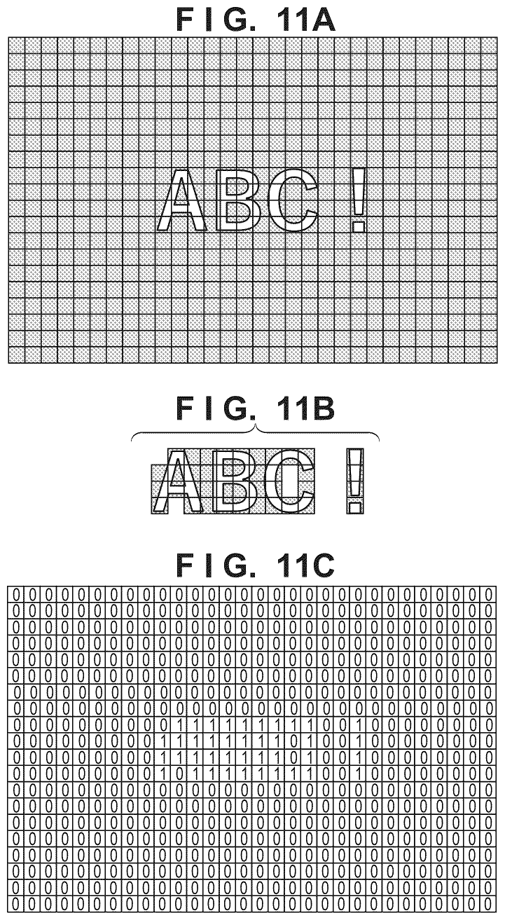

FIGS. 11A to 11C are conceptual diagrams for explaining the partially superimposed gain map 2010. FIG. 11A is an exemplary diagram of the superimposed gain map divided into blocks, FIG. 11B is an exemplary diagram showing a partial gain map included in the partially superimposed gain map 2010, and FIG. 11C is an exemplary diagram showing gain map meta information. Here, the gain map meta information shown in FIG. 11C holds for each region obtained by dividing the image into blocks, information of 1 if there is a corresponding partial gain map, and information of 0 if there is not.

The gain map generating unit 201 outputs a superimposition image file 1030 and the generated partially superimposed gain map 2010 to the gain map assigning unit 202.

In step S202, the gain map assigning unit 202 generates a new image file by adding a partial superimposed gain map to the image file. Specifically, the gain map assigning unit 202 adds the partial superimposed gain map 2010 to the input superimposition image file 1030 to generate an updated superimposition image file 2020. The updated superimposition image file generated here in this embodiment is a file including a plurality of gain maps. The gain map assigning unit 202 outputs the generated updated superimposition image file 2020 to the image output unit 107.

As described above, according to the second embodiment, in a case where an object is superimposed on an image to which a gain map is attached, it is possible to generate a gain map corresponding to the processing. In addition, by excluding the gain map except for the region where the object is superimposed, it is possible to reduce the file size.

### Third Embodiment

Next, a third embodiment of the disclosure will be described.

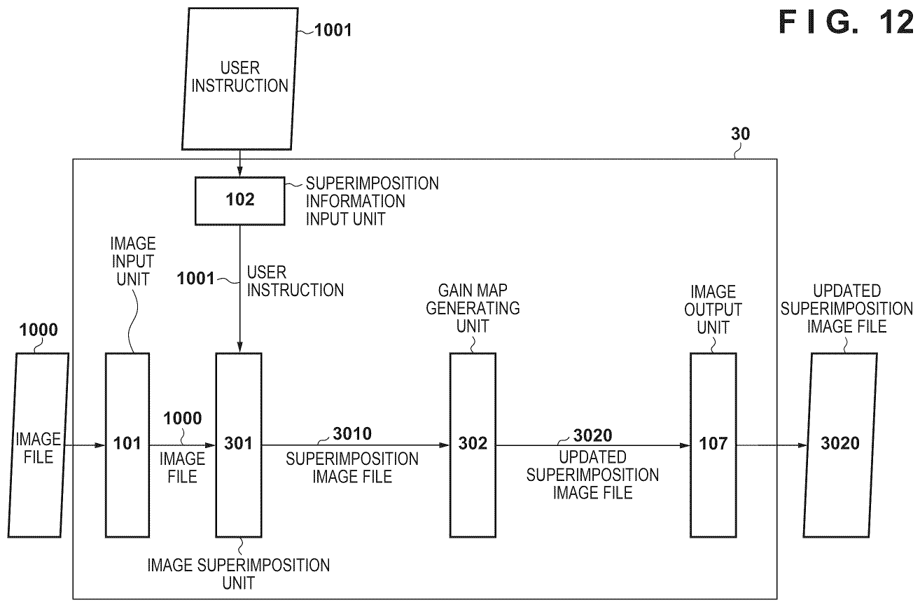

FIG. 12 is a block diagram illustrating an exemplary functional configuration of an image processing apparatus 30 according to the third embodiment.

The image processing apparatus 30 has an image input unit 101, a superimposition information input unit 102, an image superimposition unit 301, a gain map generation unit 302, and an image output unit 107. Note that in FIG. 12, components similar to those shown in FIG. 1 described in the first embodiment are given the same reference numerals, and the descriptions thereof will be omitted.

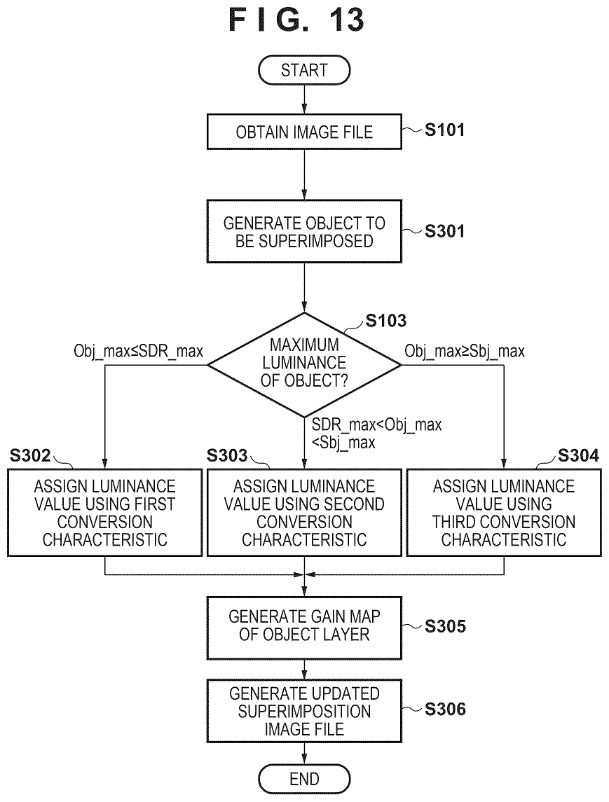

The process of superimposing an object on an image, which is performed in the third embodiment, will be described below with reference to the flowchart in FIG. 13. Note that in the processes shown in FIG. 13, the same processes as those described in the first embodiment with reference to FIG. 4 are given the same step numbers and the description thereof will be omitted.

In step S301, the image superimposition unit 301 performs object superimposition processing on HDR image data included in the input image file 1000, based on the user instruction 1001 input from the superimposition information input unit 102. In the third embodiment, an image file has a layer structure consisting of a plurality of layers, and when object superimposition is performed, for example, the image superimposition unit 301 adds a layer that records the processing content.

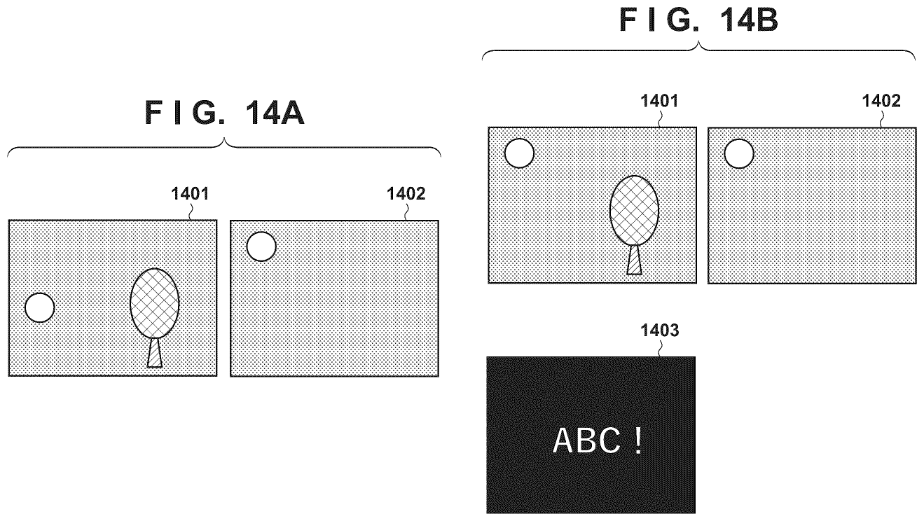

FIGS. 14A and 14B are conceptual diagrams showing superimposition of an object on an original image in object superimposition processing. FIG. 14A shows an image file 1000 before the object superimposition processing, which consists of an HDR image 1401, that is the original image, and a gain map 1402 added to the HDR image 1401. FIG. 14B shows a superimposition image file 3010 generated after the object superimposition processing, which consists of a layer consisting of the HDR image 1401 and gain map 1402, and a layer recording the contents of object superimposition processing 1403.

The image superimposition unit 301 outputs the image file on which the object superimposition processing is applied to the gain map generation unit 302 as the superimposition image file 3010.

Then, in step S103, the magnitude of the maximum luminance Obj_max of the object region is obtained based on the contents of the object superimposition processing 1403, and compared with the maximum luminance SDR_max of the SDR display device and the maximum luminance Sbj_max of the subject.

If the maximum luminance Obj_max of the object region is equal to or less than the maximum luminance SDR_max of the SDR display device, the process proceeds to step S302, where the first conversion characteristic as shown in the graph 701 of FIG. 7 is selected. Then, a luminance value is assigned using the first conversion characteristic to the luminance obtained by degammaing with respect to a layer to which no gain map is assigned in the input superimposition image file 3010. If the maximum luminance Obj_max of the object region is greater than the maximum luminance SDR_max of the SDR display device and less than the maximum luminance Sbj_max of the subject, the process proceeds to step S303, where a luminance value is assigned using the second conversion characteristic as shown in the graph 702. If the maximum luminance Obj_max of the object region is equal to or greater than the maximum luminance Sbj_max of the subject, the process proceeds to step S304, where a luminance value is assigned using the third conversion characteristic as shown in the graph 703.

Next, in step S305, the gain map generation unit 302 generates a gain map that records the ratio of the Y components of each corresponding pixel between the HDR image 1401 included in the input superimposition image file 3010 and the image converted in any of steps S302 to S304. Then, in step S306, the gain map generation unit 302 associates the generated gain map with the layer of the object superimposition processing 1403 of the superimposition image file 3010 and records it, generates an updated superimposition image file 3020, and outputs it to the image output unit 107.

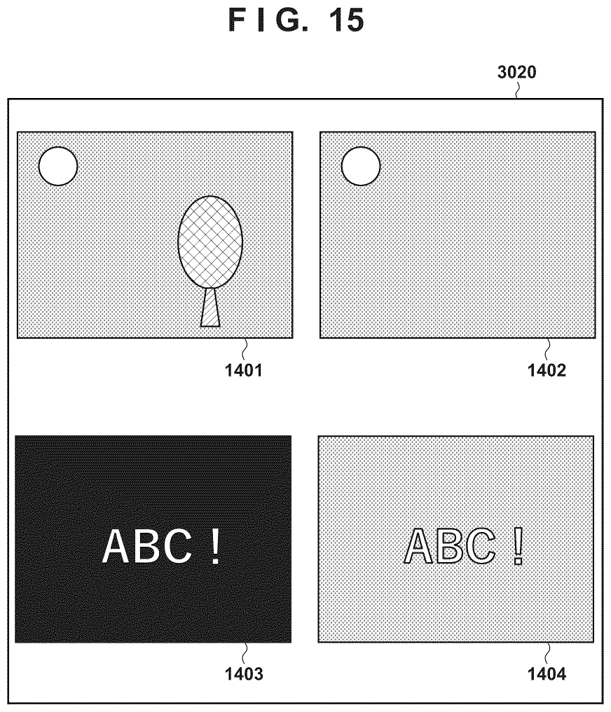

FIG. 15 shows a conceptual diagram of the updated superimposition image file 3020. The updated superimposition image file 3020 includes a layer in which the HDR image 1401 and the gain map 1402 added to the HDR image 1401 are recorded, and a layer in which the contents of object superimposition processing 1403 and a gain map 1404 corresponding to the contents of object superimposition processing 1403 are recorded.

By generating a gain map corresponding only to the object-superimposed region in this manner, it is possible to generate a gain map without being influenced by regions other than the object-superimposed region.

The number of layers in which the object superimposition processing is recorded is not limited to one, and may be plural. For example, in a case where an object is to be superimposed on an image file having a plurality of layers in which images associated with gain maps are recorded, it is possible to add another layer and perform a gain map generation processing corresponding to that layer. By performing such processing, even if an object is to be superimposed on an image on which another object has already been superimposed, it is possible to generate a gain map suitable for the newly superimposed object.

Furthermore, in a case of removing the superimposed object, the superimposed layer of that object and the gain map associated with that layer are removed, thereby removing the effect of the superimposed object from the image and the gain map.

As described above, according to the third embodiment, in a case where an object is superimposed on an image to which a gain map is associated, it is possible to generate a gain map corresponding to the object. Furthermore, by using a layer structure, it is possible to easily return to the gain map before the processing when the processing is canceled.

In the above-described first to third embodiments, the input image file 1000 is composed of an HDR image and a gain map, but it may be an image file composed of an SDR image and a gain map. Further, the gain map in this embodiment has the same number of pixels as the image, but is not limited to this, and, for example, an image may be reduced and a gain map may have the same number of pixels as the reduced image, in which case the gain map is scaled to the same number of pixels as the image before the reduction when used.

In addition, the gain of each pixel of the gain map in this embodiment is created from the ratio of Y values after degammaing the HDR image and the SDR image, but the generation method is not limited to this. For example, the gain may be a ratio of any of the RGB values obtained by converting an HDR image into an RGB image to which HDR gamma is applied, and an SDR image into an RGB image to which SDR gamma is applied. In addition, the gain map in this embodiment is one-channel data, but the present disclosure is not limited to this, and may have a three-channel data configuration of gains for respective colors R, G, and B of an RGB image, for example.

### Fourth Embodiment

Next, a fourth embodiment of the disclosure will be described.

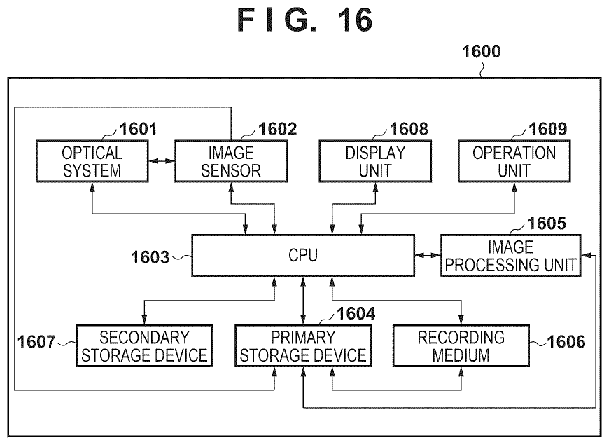

FIG. 16 is a block diagram illustrating an example of the basic functional configuration of a digital camera 1600 (hereinafter referred to as camera 1600) according to the present embodiment, as an example of an apparatus equipped with the image processing apparatus 10, 20, or 30 described in any of the first to third embodiments. The image capturing apparatus to which the disclosure can be applied shall be any electronic device equipped with a camera function. Examples of electronic devices include video cameras, computer devices (personal computers, tablet computers, media players, PDAs, etc.), mobile phones, smartphones, game consoles, robots, drones, drive recorders, etc. These are merely examples, and the present disclosure is also similarly applicable to other electronic devices.

In the camera 1600, an optical system 1601 is an imaging optical system that includes a lens group, a shutter, an aperture, etc., and forms an optical image of a subject on an imaging surface of an image sensor 1602. The lens group includes a fixed lens and a movable lens, and the movable lens includes a lens for image stabilization, a focus lens, a variable magnification lens, etc. The aperture may also have a function of a mechanical shutter. The operations of the movable lens, the aperture, and the shutter are controlled by a CPU 1603 that is a main control unit of the camera 1600. The optical system 1601 may be configured integrally with the camera 1600, or may be configured to be replaceable.

The image sensor 1602 is, for example, a CMOS image sensor, in which a plurality of pixels each having a photoelectric conversion region are arranged two-dimensionally. The image sensor 1602 also has a color filter having a specific color pattern, and each pixel is provided with a filter of one color corresponding to the color pattern. The image sensor 1602 photoelectrically converts an optical image formed on the light receiving surface by the optical system 1601 at each pixel to converts it into an analog image signal indicating luminance information for each pixel.

An analog image signal generated by the image sensor 1602 is converted into a digital image signal by an A/D converter (not shown). The A/D converter may be included in the image sensor 1602, or the CPU 1603 may perform the A/D conversion. A pixel signal constituting a digital image signal obtained by the A/D conversion is RAW data having only a luminance component of the color of a color filter provided on the pixel that generated the signal. The CPU 1603 stores this RAW data in a primary storage device 1604. The shooting sensitivity of the image sensor 1602 is set by the CPU 1603, for example, according to an instruction from a user via an operation unit 1609, a photometry result, or the like.

The CPU 1603 transfers programs stored in a secondary storage device 1607 to the primary storage device 1604 and executes the programs to control each unit of the camera 1600 and realize various functions of the camera 1600. Note that in the following description, at least some of the functions realized by the CPU 1603 executing the programs may be realized by dedicated hardware such as an ASIC.

The primary storage device 1604 is a volatile storage device such as a RAM, etc. The primary storage device 1604 is used by the CPU 1603 to execute programs, and is also used as a buffer memory for image data, a work area for image processing, a video memory for display, etc.

The secondary storage device 1607 is a rewritable nonvolatile storage device such as an EEPROM, etc. The secondary storage device 1607 stores programs (instructions) executable by the CPU 1603, settings for the camera 1600, GUI data, etc.

A recording medium 1606 is a rewritable nonvolatile storage device such as a semiconductor memory card. The recording medium 1606 may be built into the camera 1600 or may be configured to be removable from the camera 1600. Data (still image data, moving image data, audio data, etc.) generated by the camera 1600 can be recorded on the recording medium 1606. In other words, the camera 1600 has a function of reading from and writing to the recording medium 1606 and, if the recording medium 1606 is removable, has an attachment/detachment mechanism. Note that the recording destination of the data generated by the camera 1600 is not limited to the recording medium 1606, and the data may be transmitted to an external device through a communication interface of the camera 1600 and recorded on a recording device accessible by the external device, for example.

A display unit 1608 is configured with a liquid crystal display, for example. The CPU 1603 functions as a display control device for the display unit 1608. In a shooting standby state or while a moving image is being recorded, the display unit 1608 displays the shot moving image in real time, and the display unit 1608 functions as an electronic viewfinder. The display unit 1608 also displays image data recorded in the recording medium 1606 and GUI images such as menu screens.

The operation unit 1609 is a general term for a group of input devices that accept user operations, and may include, for example, a button, a lever, and a touch panel. The operation unit 1609 may also include input devices that use voice or line of sight, for example and do not require physical operation. The input devices of the operation unit 1609 are given names according to the assigned functions, and examples of the input devices include a shutter button, a menu button, a direction key, a decision (set) button, and a mode switching dial. Different functions may be selectively assigned to one input device. The operation unit 1609 may constitute a part of the superimposition information input unit 102.

An image processing unit 1605 includes any one of the image processing apparatuses 10, 20, and 30 described in the first to third embodiments, and applies predetermined image processing to image data (which may be RAW data or image data after development processing), generates image data of different formats, and obtains and/or generates various information. The image processing unit 1605 may be, for example, a dedicated hardware circuit such as an ASIC designed to realize a specific function, or may be configured to realize a specific function by a programmable processor such as a DSP executing software.

Image processing performed by the image processing unit 1605 may include, for example, preprocessing, color interpolation processing, correction processing, detection processing, data processing, evaluation value calculation processing, special effect processing, and the like.

Preprocessing may include signal amplification, reference level adjustment, defective pixel correction, and the like.

Color interpolation processing is performed in a case where a color filter is provided on the image sensor, and is a process that interpolates the values of color components that are not included in the individual pixel data that makes up the image data, and is also called demosaic processing.

Correction processing may include white balance adjustment, gradation correction, correction of image degradation caused by optical aberration of the optical system 1601 (image restoration), correction of the effects of peripheral darkening of the optical system 1601, color correction, and other processes.

Detection processing may include detection of feature regions (e.g., face region or human body region) and their movements, person recognition process, etc.

Data processing may include superimposition, gain map generation, cutting out of a region (trimming), synthesis, scaling, encoding and decoding, header information generation (data file generation), etc. The generation of image data for display and image data for recording is also included in the data processing.

Evaluation value calculation processing may include processes such as generation of signals and evaluation values used in autofocus detection (AF), and generation of evaluation values used in autoexposure control (AE).

Special effect processing may include processes such as adding a blur effect, changing color tones, and relighting.

Note that these are examples of processing to which the image processing unit 1605 can be applied, and do not limit the processing applied by the image processing unit 1605.

### Other Embodiments

The disclosure may be applied to a system made up of a plurality of devices, or to an apparatus made up of a single device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-082894, filed May 21, 2024 which is hereby incorporated by reference herein in its entirety.

What is claimed is:

1. An image processing apparatus comprising one or more processors and/or circuitry which function as:
a superimposition unit that performs superimposition processing for superimposing an object on first image data of a first dynamic range, the first image data being associated with a first gain map for converting the first dynamic range into a second dynamic range, to generate superimposed image data;
a generating unit that obtains a conversion characteristic for converting image data of the object into image data of the second dynamic range based on a luminance of the object, and generates a second gain map for converting the superimposed image data into second image data of the second dynamic range using the conversion characteristic; and
an updating unit that updates an image file consisting of the first image data and the first gain map by using the superimposed image data and the second gain map.

2. The image processing apparatus according to claim 1, wherein the updating unit has a synthesis unit that synthesizes the first gain map and the second gain map to generate a synthesized gain map, and
the updating unit replaces the first image data and the first gain map of the image file with the superimposed image data and the synthesized gain map, respectively.

3. The image processing apparatus according to claim 2, wherein the synthesis unit replaces a gain of a region of the first gain map corresponding to a region of the object with a gain of the second gain map.

4. The image processing apparatus according to claim 2, wherein the synthesis unit generates the synthesized gain map by selecting a larger gain from among the gains constituting the first gain map and the second gain map.

5. The image processing apparatus according to claim 2, wherein the synthesis unit replaces a gain of a region of the first gain map corresponding to a region of the object with a gain obtained by synthesizing the gain of the first gain map and the gain of the second gain map using a synthesis ratio of the first image data and the image data of the object used in the superimposition processing.

6. The image processing apparatus according to claim 1, wherein the updating unit generates a partial gain map corresponding to a region of the object in the second gain map and meta information representing a region of the first gain map corresponding to the region of the object, replaces the first image data of the image file with the superimposed image data, and adds the partial gain map and the meta information.

7. The image processing apparatus according to claim 1, wherein the superimposition unit generates image data of the object of the first dynamic range as the superimposed image data, and
the updating unit adds the superimposed image data and the second gain map to the image file.

8. The image processing apparatus according to claim 1, wherein the generating unit
converts the superimposed image data into the second image data of the second dynamic range using the conversion characteristic, and
calculates a gain for converting the superimposed image data into the second image data for each predetermined region to generate the second gain map.

9. The image processing apparatus according to claim 8, wherein the predetermined region is each pixel.

10. The image processing apparatus according to claim 8, wherein the predetermined region is each region obtained by dividing a plurality of pixels constituting the second image data.

11. An electronic apparatus comprising:
an image processing apparatus comprising one or more processors and/or circuitry which function as:
a superimposition unit that performs superimposition processing for superimposing an object on first image data of a first dynamic range, the first image data being associated with a first gain map for converting the first dynamic range into a second dynamic range, to generate superimposed image data;
a generating unit that obtains a conversion characteristic for converting image data of the object into image data of the second dynamic range based on a luminance of the object, and generates a second gain map for converting the superimposed image data into second image data of the second dynamic range using the conversion characteristic; and
an updating unit that updates an image file consisting of the first image data and the first gain map by using the superimposed image data and the second gain map, and
an image sensing unit that performs shooting, generates and outputs image data of the first dynamic range.

12. An electronic apparatus comprising:
an image processing apparatus comprising one or more processors and/or circuitry which function as:
a superimposition unit that performs superimposition processing for superimposing an object on first image data of a first dynamic range, the first image data being associated with a first gain map for converting the first dynamic range into a second dynamic range, to generate superimposed image data;
a generating unit that obtains a conversion characteristic for converting image data of the object into image data of the second dynamic range based on a luminance of the object, and generates a second gain map for converting the superimposed image data into second image data of the second dynamic range using the conversion characteristic; and
an updating unit that updates an image file consisting of the first image data and the first gain map by using the superimposed image data and the second gain map, and
an output unit that converts the image data of the first dynamic range included in the image file output from the image processing apparatus using a gain map included in the image file, and outputs the converted image data to a display device of the second dynamic range.

13. An image processing method comprising:
performing superimposition processing for superimposing an object on first image data of a first dynamic range, the first image data being associated with a first gain map for converting the first dynamic range into a second dynamic range, to generate superimposed image data;
obtaining a conversion characteristic for converting image data of the object into image data of the second dynamic range based on a luminance of the object, and generating a second gain map for converting the superimposed image data into second image data of the second dynamic range using the conversion characteristic; and
updating an image file consisting of the first image data and the first gain map by using the superimposed image data and the second gain map.

14. A non-transitory computer-readable storage medium, the storage medium storing a program that is executable by the computer, wherein the program includes program code for causing the computer to function as an image processing apparatus comprising:
a superimposition unit that performs superimposition processing for superimposing an object on first image data of a first dynamic range, the first image data being associated with a first gain map for converting the first dynamic range into a second dynamic range, to generate superimposed image data;
a generating unit that obtains a conversion characteristic for converting image data of the object into image data of the second dynamic range based on a luminance of the object, and generates a second gain map for converting the superimposed image data into second image data of the second dynamic range using the conversion characteristic; and
an updating unit that updates an image file consisting of the first image data and the first gain map by using the superimposed image data and the second gain map.
